(19) United States
(12) Patent Application Publication
(10) Pub. No.: US 2015/0334178 A1
(43) Pub. Date: Nov. 19, 2015

(54) Method and Apparatus for Data Transmission Oriented on the Object, Communication Media, Agents, and State of Communication Systems

(71) Applicant: Mykhaylo Sabelkin, Fairborn, OH (US)

(72) Inventor: Mykhaylo Sabelkin, Fairborn, OH (US)

(21) Appl. No.: 14/809,727

(22) Filed: Jul. 27, 2015

Related U.S. Application Data
(63) Continuation of application No. 13/090,608, filed on Apr. 20, 2011.

(51) Int. Cl. H04L 29/08

(52) U.S. Cl. CPC H04L 67/10

(57) ABSTRACT

A method and apparatus for Data Transmission Oriented on the Object, Communication Media, Agents, and State of Communication Systems (TOMAS) is disclosed. TOMAS addresses an issue of efficiency of conventional data communication systems. The superior efficiency of TOMAS is achieved by: 1) matching the requirements of agents with capabilities of the communication systems and the communication media using the features of data objects; 2) monitoring of time-varying characteristics of all components, such as a charge of batteries and a status of all hardware, firmware and software components; 3) using an information about time-invariant characteristics of the systems, such as devices screen sizes, employed operational systems (OS), etc.; 4) using a flexible system architecture; and 5) using a fast signal processing algorithm described in [1] at the stage of data object analysis-synthesis and the codestream multiplexing-demultiplexing.

### CROSS-REFERENCE TO RELATED APPLICATIONS

### Related U.S. Application Data

This is a continuation of application Ser. No. 13/090,608, filed on Apr. 21, 2011

### Foreign Application Priority Data

May 3, 2010

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of data communication. More particularly, the present invention is in the technical field of wired and wireless data communication systems. The data communication systems, other than wireless, are considered as the wired data communication systems. Data communication systems serve to transmit certain data from one place to another. Conventional data communication systems have limited capabilities in parameters that characterize efficiency of data transmission.

### BRIEF SUMMARY OF THE INVENTION

The present invention is a method and apparatus for Data Transmission Oriented on the Object, Communication Media, Agents, and State of Communication Systems (TOMAS). The efficiency of data communication of the proposed method and apparatus is superior than the one of the conventional data communication systems. The superior efficiency is achieved by matching the requirements of agents with capabilities of the communication systems and the communication media using the features of the data objects. Data objects are represented by the digital or/and non-compressed data of different type, size, nature, etc. The object can be a one-dimensional (1D) signal, such as an audio signal, a voice, a control sequence; or/and a two-dimensional (2D) signal, such as a grayscale image; or/and a three dimensional signal (3D), such as a static 3D mesh or a color image; or/and a four dimensional signal, such as a dynamic 3D mesh or a color video signal; or/and a five dimensional signal such as a stereo color video signal. The communication media is a wireless link, a twisted pair cable, a coaxial cable, a fiber optic link, or a waveguide. The agents can be human or/and not human. The not human agent is represented by a hardware device or/and a firmware program or/and a software program. The communication systems are complex devices that employ multiple hardware, firmware and software components. An efficient data communication depends on reliable functioning of all components. It is provided by monitoring of time-varying characteristics of all components, such as a charge of batteries and a status of all hardware, firmware and software components. An efficient data communication also depends on information about time-invariant characteristics of the systems, such as devices screen sizes, employed operational systems (OS), etc. The superior efficiency of TOMAS is also achieved by using a fast signal processing algorithm described in [1] at the stage of data object analysis-syntesis and the codestream multiplexing-demultiplexing. The superior efficiency of TOMAS for wireless communication media is achieved by modeling a wireless channel profile using a fast signal processing algorithm described in [1]. The obtained channel model predicts attenuations of each of subbands. Use of this information allows organizing datastream coding, mapping and multiplexing more efficiently.

### BRIEF DESCRIPTION OF THE DRAWINGS

FIG. 1 is a general structure of the Data Transmission Oriented on the Object, Communication Media, Agents, and State of Communication Systems;

FIG. 2 is a TOMAS transceiver structure;

FIG. 3 is a data communication using two TOMAS transceivers;

FIG. 4 is a structure of the data segment after the bit-plan conversion.

### DETAILED DESCRIPTION OF THE INVENTION

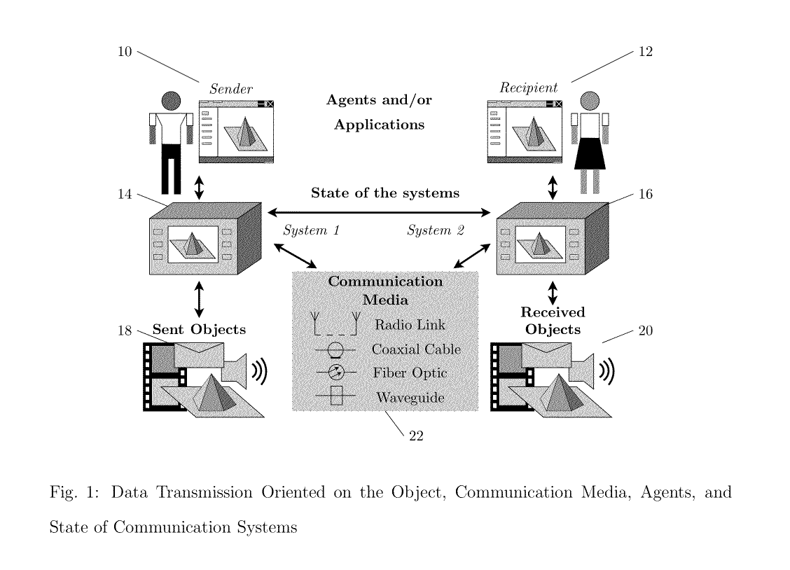

Referring now to the invention in more detail. Data Transmission Oriented on the Object, Communication Media, Agents, and State of Communication Systems is possible in case of two or more communication systems. In FIG. 1 there is shown a structure of the Data Transmission Oriented on the Object, Communication Media, Agents, and State of Communication Systems.

Sent objects 18 are represented by the digital or/and analog non-compressed data of different type, size, nature, etc. Received objects 20 are represented by the digital or/and analog compressed or non-compressed data of different type, size, nature, etc. The object can be a one-dimensional (1D) signal, such as an audio signal, a voice, a control sequence; or/and a two-dimensional (2D) signal, such as a grayscale image; or/and a three dimensional signal (3D), such as a static 3D mesh or a color image; or/and a four dimensional signal, such as a dynamic 3D mesh or a color video signal; or/and a five dimensional signal such as a stereo color video signal.

The object which contains a combination of the signals mentioned above can be referred as a multimedia object.

A communication media 22 is a wireless link, a twisted pair cable, a coaxial cable, a fiber optic link, or a waveguide.

A sender 10 and a recipient 12 are agents. The agents can be human or/and not human. The not human agent is represented by a hardware device or/and a firmware program or/and a software program.

A communication system 14 and a communication system 16 are complex devices that employ multiple hardware, firmware and software components. An efficient data communication depends on reliable functioning of all components. It is provided by monitoring of time-varying characteristics of all components, such as a charge of batteries and a status of all hardware, firmware and software components. An efficient data communication also depends on information about time-invariant characteristics of the systems, such as devices' screen sizes, employed operational systems (OS), etc.

The sender 10 interacts with the communication system 14 to send the data objects 18. The communication system 14 interacts with the communication system 16 over the communication media 22 in order to determine the parameters of the communication media 22. The communication system 14 transforms the data objects 18 into data suitable to be transmitted over the communication media 22. The communication system 14 transmits the transformed data objects 18 to the communication system 16 over the communication media 22 once the link between the communication system 14 and the communication system 16 has been established. The communication system 16 receives the data from the communication system 14. Often the received data is not the same one which has been transmitted by the communication system 14 due to distortion and/or corruption in the communication media 22. That is why the received objects 20 are not often the same ones that has been transmitted by the communication system 14. The communication system 16 implements an inverse transform of the received data in order to obtain the received objects 20. A recipient 12 interacts with a communication system 16 to obtain the received objects 20. The recipient 12 interacts with the sender 10 to provide a feedback information about parameters of the received objects 20. The sender 10 interacts with the recipient 12 to obtain an information about the received objects' 20 parameters required by the recipient 12.

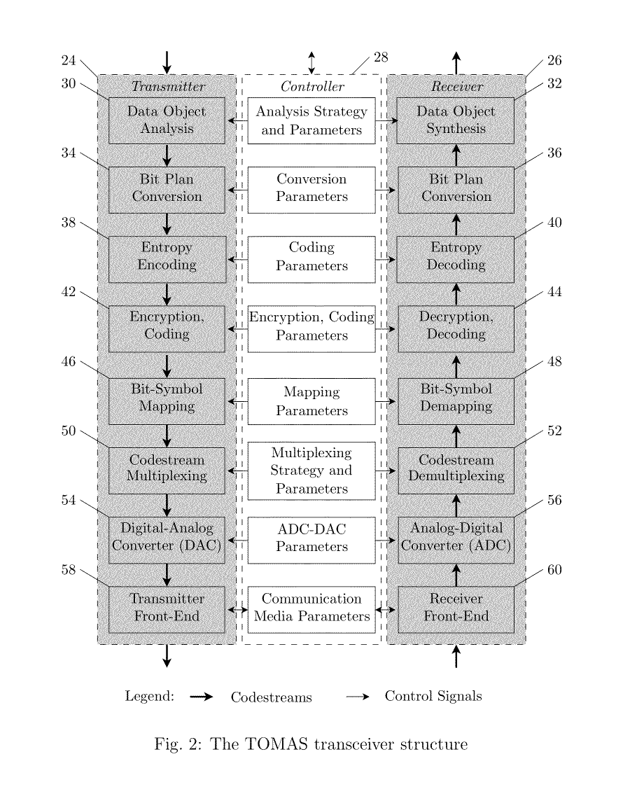

FIG. 2 represents the structure of communication systems 14 and 16. Each of the systems 14 and 16 consists of a transmitter 24, a receiver 26, and a controller 28. The system which contains both the transmitter and the receiver is often referred as a transceiver. Hence FIG. 2 represents the structure of the transceiver which implements a method of Data Transmission Oriented on the Object, Communication Media, Agents, and State of Communication Systems. Further, the transceiver shown on FIG. 2 is referred as the TOMAS transceiver.

The transmitter 24 consists of a data object analysis block 30, a bit-plan conversion block 34, an entropy encoding block 38, an encryption or/and channel coding block 42, a bit-symbol mapping block 46, a codestream multiplexing block 50, a digital-to-analog (DAC) signal converter block 54, and a transmitter front-end block 58.

The transmitter 24 inputs the sent objects 18, and outputs the data suitable to be transmitted over the particular communication media 22.

The receiver 26 consists of a data object synthesis block 32, a bit-plan conversion block 36, an entropy decoding block 40, a decryption or/and channel decoding block 44, a bit-symbol demapping block 48, a codestream demultiplexing block 52, an analog-to-digital (ADC) signal converter block 56, and a receiver front-end block 60.

The receiver 26 inputs the data transmitted over the particular communication media 22, and outputs the received objects 20.

The controller 28 operates with all transceiver parameters. They are the data object analysis and decomposition parameters, the bit-plan conversion parameters, the entropy encoding parameters, the encryption or/and channel coding parameters, the bit-symbol mapping parameters, the codestream multiplexing parameters, the digital-to-analog and analog-to-digital conversion parameters, and the communication media front-end parameters.

The controller 28 interacts with the sender 10. The controller 28 also interacts with the recipient 12 via the communication media 22.

Legend on FIG. 2 emphasize that the bold arrows between blocks represent codestreams, and the thin arrows represent control signals.

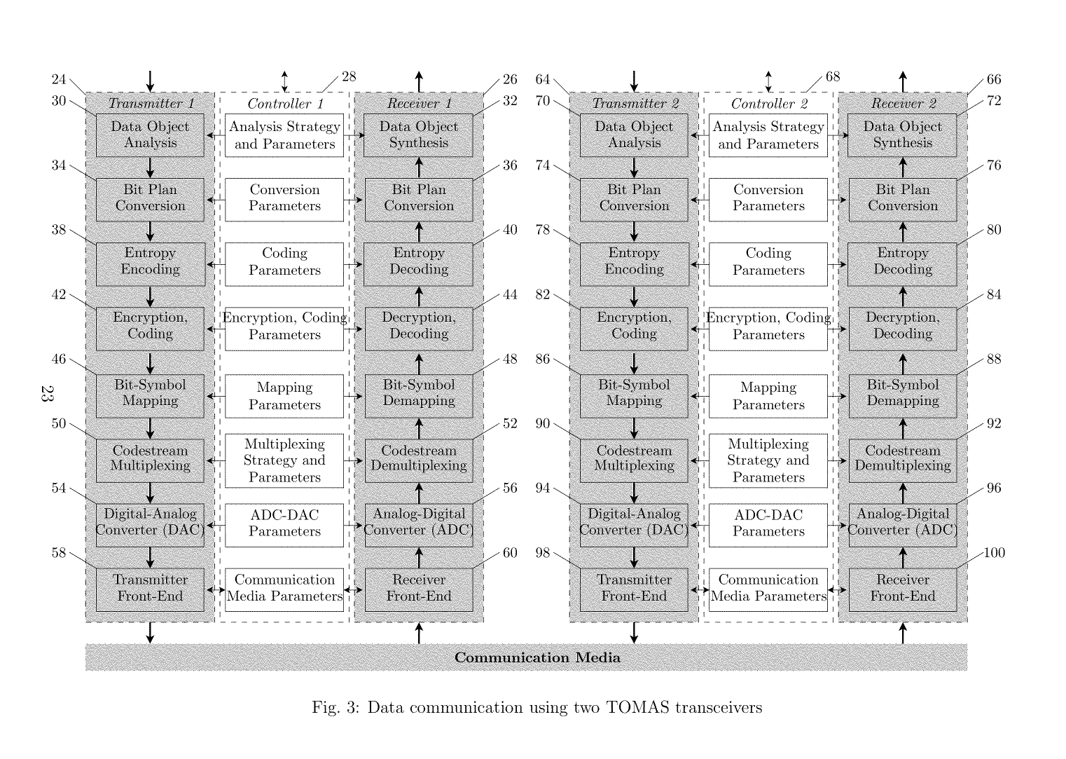

The communication system 14 is called the first TOMAS transceiver. The communication system 16 is called the second TOMAS transceiver. Data communication using two TOMAS transceivers is shown on FIG. 3. The first TOMAS transceiver consists of a transmitter 24, a receiver 26 and a controller 28. The second TOMAS transceiver consists of a transmitter 64, a receiver 66 and a controller 68.

Data communication between two TOMAS transceivers is divided into two stages. The first stage is establishing a link between two TOMAS transceivers. The second stage is actual data transmission from one transceiver to another.

At the first stage, the controller 28 checks the state of the hardware, firmware and software components of the first TOMAS transceiver 14, and the controller 68 checks the state the state of the hardware, firmware and software components of the second TOMAS transceiver 16.

In case all components of the first TOMAS transceiver 14 are functional, the controller 28 responds to the agent 10 that the TOMAS transceiver 14 is fully operational and the data communication is possible. In case all components of the second TOMAS transceiver 16 are functional, the controller 68 responds to the agent 12 that the TOMAS transceiver 16 is fully operational and the data communication is possible.

In case some non-significant component of the first TOMAS transceiver 14 is not functional, the controller 28 returns to the agent 10 a set of hardware, firmware and software components' configurations that make the TOMAS transceiver 14 partially operational and data communication possible. In case some non-significant component of the second TOMAS transceiver 16 is not functional, the controller 68 returns to the agent 12 a set of hardware, firmware and software components' configurations that make the TOMAS transceiver 16 partially operational and data communication possible.

In case some critical component of the first TOMAS transceiver 14 is not functional, the controller 28 responds to the agent 10 that the TOMAS transceiver 14 is not operational and the data communication is impossible. In case some critical component of the second TOMAS transceiver 16 is not functional, the controller 68 responds to the agent 12 that the TOMAS transceiver 16 is not operational and the data communication is impossible.

After the controller 28 determined that the TOMAS transceiver 14 is fully or partially operational it commands the transmitter 24 to send a “handshake” signal to the TOMAS transceiver 16 over the communication media 22.

After the controller 68 determined that the TOMAS transceiver 16 is fully or partially operational it commands the receiver 24 to wait for the “handshake” signal from the TOMAS transceiver 14 over the communication media 22.

The procedure of sending the “handshake” signal might differ from one communication media type to another. In most cases it would be a signal of certain pattern which is known a-priori by the transmitter 24 and the receiver 66.

After receiver 66 receives the “handshake” signal, the controller 68 commands the transmitter 64 to send a “link established” signal to the TOMAS transceiver 14.

In case communication media 22 is represented by multiple frequency channels, the procedure of sending the “handshake” signal might be repeated by the TOMAS transceiver 14 on multiple frequencies until the “link established” signal will be received from the TOMAS transceiver 16.

After establishing a link between two TOMAS transceivers, the controller 28 and the controller 68 exchange information about the hardware, firmware and software components' configurations and the states of each of the TOMAS transceivers.

The controller 28 commands the transmitter 24 to send a signal for measurement of the communication media parameters. The receiver 66 receives the measurement signal, and the controller 68 processes it by extracting the communication media parameters critical for the data communication. The controller 68 commands the transmitter 64 to send the communication media parameters to the receiver 26. The receiver 26 provides the controller 28 with the communication media parameters.

The controller 68 interacts with the recipient 12. The last one can impose certain requirements on the data objects he wants to receive. For example, in case of the image, the recipient 12 can ask the image of different size and/or resolution. The controller 68 commands the transmitter 64 to send the recipient 12 requirements to the receiver 26. The receiver 26 provides the controller 28 with the recipient 12 requirements.

The first stage of establishing a link between the TOMAS transceiver 14 and the TOMAS transceiver 16 is accomplished. After the first stage, the controller 28 of the TOMAS transceiver 14 possesses the information about the communication media parameters, the information about the hardware, firmware and software components' configurations, the state of the TOMAS transceiver 16, and the information about requirements of the agent 12 on the data objects they want to receive.

At the second stage of data transmission from the TOMAS transceiver 14 to the TOMAS transceiver 16, the controller 28 uses the information about the communication media parameters, the information about the hardware, firmware and software components' configurations, the state of both TOMAS transceivers 14 and 16, and the information about requirements of the agent 12 on the data objects they want to receive.

The agent 10 provides the TOMAS transceiver 14 with the data objects 18. The agent 10 can provide the controller 28 the information about the nature of the data objects 18. The agent 10 can impose some requirements on how to proceed with the processing of the data objects 18. The agent 10 can propose an analysis/synthesis technique to be employed by the controller 28 on a particular data object type. However the final choice of the data object analysis/synthesis technique is made by the controller 28. The choice of the data object analysis/synthesis technique is stipulated by the information about the communication media throughput capability, the information about the both TOMAS transceivers' capability, and the information about requirements of the agent 12 on the data objects they want to receive.

The task of the controller 28 is to look for a compromise between agents' demands on object transmission, and communication media/communication system capabilities. In order to fulfill such a task, the controller 28 assigns appropriate parameters to the transceiver's 24 blocks.

The controller 28 chooses an appropriate analysis/synthesis technique for the particular data object. The chosen technique might be appropriate in terms of the received object quality, an algorithm computation speed or complexity, availability of hardware, firmware and software resources to implement such a technique at the moment. Even an intellectual property rights on some particular technique might also be taken into consideration.

The data object analysis block 30 decomposes the sent data object into data segments using the analysis technique assigned by the controller 28. Using some quality criterion of the restored data object, the controller 28 assigns every data segment with a certain index of importance. The first data segment is considered to be more important than the second one, if corruption of the first segment causes more damage to the restored data object than corruption of the second segment. The data object analysis block 30 outputs a set of data segments ranked in descending order according to their importance. The data object analysis block 30 transfers to the controller 28 a list of the data segments ranked according to their importance.

The controller 28 commands the transmitter 24 to send the parameters of the analysis techniques of each of sent data objects, and the list of the data segments ranked according to their importance. The receiver 66 receives that information and transfers it to the controller 68. Afterwards, the controller 68 transfers the set of analysis parameters to the data object synthesis block 72.

The data object synthesis block 72 restores the data objects from the data segments. The restored data objects are transferred to the recipient 12 as the received objects 20.

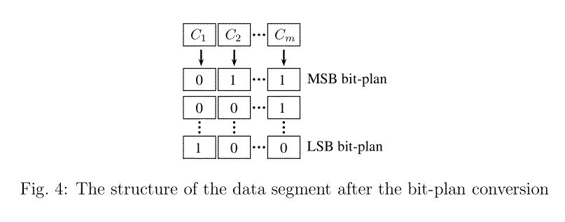

The data object analysis block 30 outputs the data segments represented by floating-point numbers. Upon a request of the controller 28, the bit-plan conversion block 34 transforms the data segments' numbers into fixed-point representation. Truncation or rounding of floating-point numbers might cause the degradation of quality of the restored data object. The bit-plan conversion block 34 represents the second stage of decomposition of the data object into data segments of unequal importance. The bit-plans of the data segment are formed by grouping corresponding bits of the coefficients as it is shown on FIG. 4. The bit-plan of the data segment that consists of the Most Significant Bits (MSB) of the coefficients C₁ . . . Cₘ is considered to be the most important. The bit-plan of the data segment that consists of the Least Significant Bits (LSB) of the coefficients C₁ . . . Cₘ is considered to be the least important. Upon a request of the controller 28, the bits of each bit-plan are grouped into words. The word length can differ from one bit-plan to another as well as from one data segment to another.

The controller 28 commands the transmitter 24 to send the parameters of the bit-plan conversion of each of data objects' segments. The receiver 66 receives that information and transfers it to the controller 68. Afterwards, the controller 68 transfers a set of bit-plan conversion parameters to the bit-plan conversion block 76.

The entropy encoding block 38 serves to reduce the redundancy of the bit-plan data. The entropy encoding block might implement a Huffman or arithmetic encoding algorithm. The entropy encoding technique consists of two principal stages. The first one is to build the code from the data histogram. And the second one is to encode the data using the obtained code. Upon a request of the controller 28, the entropy encoding block 38 can process separately every data segment of every data object of every bit-plan. Or, upon the request of the controller 28, the entropy encoding block 38 can process separately the bit-plans of all data segments of every data object. Or, upon the request of the controller 28, the entropy encoding block 38 can process separately the bit-plans of all data segments of all data objects. Otherwords, the controller 28 can choose different bit-plan conversion strategy.

The controller 28 commands the transmitter 24 to send the parameters of the entropy encoding. The receiver 66 receives that information and transfers it to the controller 68. Afterwards, the controller 68 transfers a set of the entropy encoding parameters to the entropy decoding block 80.

The entropy encoding block 38 outputs multiple binary code streams of two types: data histograms and entropy encoded data. The data histograms serves to restore an original entropy code. This code is required to decode the entropy encoded data. The data histograms are small is size and very prone to corruption. The entropy encoded data is also prone to corruption. The following rule is true: the shorter entropy code, the less entropy encoded data is prone to corruption. However, decrease of entropy code length leads to increase of entropy encoded data amount needed to be transmitted. The role of the controller 28 is to find an optimal code length to satisfy the conditions of the data transmission.

Upon request of the agents 10 and 12, the controller 28 can be required to apply encryption on bitstreams. This is implemented in the encryption/coding block 42. Given harsh communication media 22 conditions, the controller can command to apply a channel coding technique which is also implemented in the encryption/coding block 42.

The controller 28 commands the transmitter 24 to send the parameters of the encryption and/or channel coding. The receiver 66 receives that information and transfers it to the controller 68. Afterwards, the controller 68 transfers a set of the encryption and/or channel coding parameters to the decryption/decoding block 84. The encryption/coding block 42 outputs multiple bitstreams.

The bit-symbol mapping block 46 improves spectral efficiency of the TOMAS transceiver by mapping a group of bits into a complex symbol. A definition of spectral efficiency is presented in Equation (1) below. Upon a request of the controller 28, every bitstream can be mapped using a different or the same bit-symbol mapping technique. The type of the mapping technique depends on communication media's 22 conditions, a digital-to-analog converter (DAC) block's 54 resolution and analog-to-digital converter (ADC) block's 96 resolution. For example, the controller 28 cannot propose the 10 bit quadrature amplitude bit-symbol mapping in case the resolution of the analog-to-digital converter 96 is eight bit only and a noise level in the communication channel is too high. In most cases the bit-symbol mapping block 46 outputs the multiple parallel streams of complex symbols.

The controller 28 commands the transmitter 24 to send the parameters of the bit-symbol mapping. The receiver 66 receives that information and transfers it to the controller 68. The controller 68 transfer a set of the bit-symbol mapping parameters to the bit-symbol demapping block 88.

The multiple parallel code streams of complex symbols are multiplexed by the codestream multiplexing block 50 in order to be sent serially. This parallel-to-serial conversion can be implemented by traditional techniques such as: Time-Division Multiplexing (TDM), Code-Division Multiplexing (CDM), Frequency Division Multiplexing (FDM), Orthogonal Frequency Division Multiplexing (OFDM); or a novel multiplexing technique based on a fast signal processing method described in [1]. The superior efficiency of TOMAS for wireless communication media is achieved by modeling a wireless channel profile using a fast signal processing algorithm described in [1]. The obtained channel model predicts attenuations of each of subbands. Use of this information allows organizing datastream coding, mapping and multiplexing more efficiently.

The controller 28 chooses an appropriate parallel-to-serial conversion technique. The controller 28 commands the transmitter 24 to send the parameters of the parallel-to-serial conversion technique. The receiver 66 receives that information and transfers it to the controller 68. The controller 68 transfers a set of the parallel-to-serial conversion parameters to the codestream demultiplexing block 92.

The digital-to-analog converter (DAC) block 54 transforms a serial complex digital signal of fixed bit resolution into an analog signal, often called an intermediate frequency (IF) signal.

The TOMAS transceiver 14 contains a transmitter front-end 58 and a receiver front-end 60. The TOMAS transceiver 16 contains a transmitter front-end 98 and a receiver front-end 100. A type of front-end depends on the communication media 22. The wireless link, twisted pair cable, coaxial cable, fiber optic link, or waveguide requires different transmitter and receiver front-ends. Commonly, the transmitter front-ends 58 and 98 transform the intermediate frequency (IF) signals into higher frequency signals and transmit them over some particular communication media. In some cases the high-frequency signal is transmitted over multiple communication media types. For example, the coaxial cable is connected from the transmitter output to the antenna emitting in an open space. Another coaxial cable is connected from the antenna to the receiver input. In this case we have three communication media types serving as the communication media 22.

The receiver front-ends 60 and 100 receive higher frequency signals and transform them into the intermediate frequency (IF) signals.

Using the parameters provided by the controller 68, the analog-to-digital converter (ADC) block 96 transforms the analog intermediate frequency (IF) signal into the serial complex digital signal of fixed bit resolution.

Using the parameters provided by the controller 68, the codestream demultiplexing block 92 transforms the serial codestream into the multiple parallel codestreams.

Using the parameters provided by the controller 68, the bit-symbol demapping block 88 transforms the multiple parallel codestreams of complex symbols into the multiple parallel binary codestreams.

Using the parameters provided by the controller 68, the decryption/channel decoding block 84 transforms the multiple parallel binary codestreams into the multiple parallel bitstreams.

Using the parameters provided by the controller 68, the entropy decoding block 80 rebuilds the entropy code from the received histograms, and decodes the data segment words.

Using the parameters provided by the controller 68, the bit-plan conversion block 76 transforms the data segment words into the data segment bit-plans and afterwards into the coefficients of data object segments.

Using the parameters provided by the controller 68, the data object synthesis block 72 assembles the data objects from their segments.

Finally, the recipient 12 receives their data objects. This concludes description of the method of data Transmission Oriented on the Object, Communication Media, Agents, and State of Communication Systems for the case of a pair of communication systems.

### Performance Parameters of Communication System

In order to evaluate the performance of a communication system, the following parameters are used:

$$\begin{matrix}Spectral Efficiency = \frac{Total Object Bits}{Transmitted Symbols} , & ( 1 ) \\ Complexity = \frac{Total Processing Operations}{Total Object Bits} , & ( 2 )\end{matrix}$$

Spectral efficiency (1) is measured in bits-per-symbol. It depends on number of transmitted symbols. Hence, the communication system has high spectral efficiency when it represents the data object by a minimal number of symbols. One should note that, in case of fixed symbol mapping parameters, any kind of channel coding employed by the system will decrease the spectral efficiency.

Complexity of the communication system is measured by the Algorithm Complexity parameter (2). It reflects how many real additions and multiplications are required in order to process one bit of the transmitted data object.

The invention can be implemented in a form of software, firmware running on computing devices or a hardware. Despite the fact that data communication is possible in case of at least two TOMAS transceivers, the scenarios of communication between multiple TOMAS transceivers are also considered.

While the invention has been shown and described with reference to certain preferred embodiments thereof, it will be understood by those skilled in the art that various changes in form and details may be made therein without departing from the spirit and scope of the invention as defined by the appended claims.

### REFERENCES

[1] M. Sabelkin, “Method and apparatus for data transmission oriented on the object, communication media, agents, and state of communication systems,” patent application U.S. Ser. No. 13/090,608, filed on Apr. 21, 2011.

What is claimed:

1. A method for efficient transmission of at least one data object from a sender to at least one recipient, comprising:
the acts, performed by said recipient, of:
initiating and terminating a transmission session;
sending a request for a particular data object and a request for particular terms of transmission of said data object;
canceling said transmission session or negotiating new terms of transmission in case said transmission session is denied by said sender;
changing the particular terms of transmission during said transmission session;
analyzing a received data object;
the acts, performed by said sender, of:
replying to said recipient with a confirmation of availability of a requested data object;
requesting a sender communication system to obtain an information about capabilities and operability of both sender and recipient communication systems and capability of a communication media;
estimating if it is physically possible to transmit said requested data object over said communication media in its current state at the particular terms of transmission requested by said recipient;
defining data processing techniques to be applied in order to fulfill the particular terms of transmission requested by said recipient;
estimating if said recipient communication system is capable to implement said data processing techniques;
confirming or denying said transmission session at the particular terms requested by said recipient;
informing said recipient that said transmission session at the particular terms requested by said recipient is impossible, and proposing the new terms of transmission taking into consideration a capability of said recipient communication system;
informing said recipient that the current capacity of said communication media unable to provide the data object transmission at the particular terms requested by said recipient;
the acts, performed by said sender communication system, of:
requesting said recipient communication system said information about capabilities and operability of said recipient communication system;
interacting with said recipient communication system to estimate said capability of communication media in its current state;
decomposing said requested data object into a set of data object features using decomposition techniques supported by said recipient communication system;
providing said recipient communication system with decomposition parameters used during decomposition of said requested data object into said set of data object features;
organizing, processing and preparing said set of data object features for transmission over said communication media;
interacting with said recipient communication system during said transmission session of said data object features to estimate said capability of said communication media in its current state;
taking corrective actions in case capability of said communication media in its current state changes insignificantly;
informing said sender about a drastic change in capability of said communication media in its current state;
the acts, performed by said recipient communication system, of:
replying with said information about capabilities, operability and flexibility of said recipient communication system;
receiving and processing said set of received data object features;
restoring a received data object from a set of received data object features;
informing said recipient and said sender communication system that a data object is received;
whereby superior efficiency of data transmission is achieved by instant matching the requirements of both said sender and said recipient(s) with said capabilities of said communication systems and said communication media using the features of said data object(s).

2. The method according to claim 1 wherein said sender and said recipient are human and/or not human.

3. The method according to claim 1 wherein said data object is represented by a digital data of plural types, sizes, nature, and dimensions.

4. The method according to claim 1 wherein said communication media is represented by wireless and wired communication media.

5. A system for efficient data communication implementing the method according to claim 1.

6. A communication network comprising at least two systems operating according to claim 5.
